(19) United States
(12) Patent Application Publication
(10) Pub. No.: US 2013/0088195 A1
(43) Pub. Date: Apr. 11, 2013

(54) Wireless Charging Apparatus For Vehicle

(71) Applicants: Young Seok YOON, Cheonan-si (KR); Eung Ju KIM, Suwon (KR)

(72) Inventors: Young Seok YOON, Cheonan-si (KR); Eung Ju KIM, Suwon (KR)

(73) Assignee: SAMSUNG ELECTRO-MECHANICS CO., LTD., Gyunggi-do (KR)

(21) Appl. No.: 13/607,479

(22) Filed: Sep. 7, 2012

(30) Foreign Application Priority Data
Oct. 5, 2011 (KR) 10-2011-0101427

(51) Int. Cl. H02J 7/00

(52) U.S. Cl. 320/108

(57) ABSTRACT

Disclosed is a wireless charging apparatus for a vehicle. The wireless charging apparatus for a vehicle includes: a cavity type charging receiving part formed on a dashboard of a vehicle so as to charge a portable terminal; a pair of streamlined elastic fixing parts mounted in the cavity type charging receiving part to press and fix the portable terminal; and a charging module mounted on a rear surface of the cavity type charging receiving part and mounted with a primary side coil transmitting a wireless power signal so as to automatically align and charge the primary side coil at aligning a position of a secondary side coil of the portable terminal, whereby the position of the primary side coil is automatically aligned to correspond to the position of the secondary side coil, thereby improving the wireless power transmission efficiency.

### CROSS REFERENCE TO RELATED APPLICATION

This application claims the benefit of Korean Patent Application No. 10-2011-0101427, filed on Oct. 5, 2011, entitled “Wireless Charging Apparatus For Vehicle”, which is hereby incorporated by reference in its entirety into this application.

### BACKGROUND OF THE INVENTION

1. Technical Field

The present invention relates to a wireless charging apparatus for a vehicle.

2. Description of the Related Art

Generally, most of the wireless communication devices need to be charged. Therefore, portable devices recently released have different types of wired connections.

As an electrical connection method between a charger for charging electric energy in a battery pack used for a portable terminal and the battery pack, there is a terminal connection method for receiving commercial power and converting the received commercial power into voltage and current corresponding to the battery pack to supply the electric energy to the battery pack through a terminal of the corresponding battery pack.

However, in the terminal connection method of supplying power, when the charger and the battery pack are contacted and separated to and from each other, the terminals (a terminal of the battery pack and a terminal of the charger) of both sides thereof have different potential differences to lead to an instantaneous discharge phenomenon. Therefore, when foreign materials are accumulated at both sides thereof, it is likely to cause fire, or the like.

In addition, the electric energy charged in the battery pack may be naturally discharged to the outside through the terminal of the battery pack due to humidity, or the like, such that the lifespan and performance of the battery pack may be reduced.

Therefore, in order to overcome inconvenience of charging in a wired manner using the terminal connection method, the wireless charging technology has been rapidly developed. The wireless charging technology has mainly used a magnetic resonance method and a magnetic-inductive method.

Among others, the magnetic-inductive method that is a safe method less harmful to a human body than the magnetic resonance method that may configure a system chargeable over a slightly longer distance but may propagate to a human body or other devices has been used. Therefore, the development of the non-contact wireless charging technology and the propagation of a product rather than the terminal connection method has been rapidly progressed.

However, the non-contact wireless charging apparatus for a vehicle using the magnetic-inductive method mounted in the vehicle according to the preferred embodiment of the present invention has a problem in that the portable terminal may be separated from a supporter due to impact or shaking while a vehicle is traveling.

In addition, even though a position of a primary side coil embedded in the wireless charging apparatus is not matched with a position of a secondary side coil embedded in the portable terminal at the time of charging by mounting the portable terminal in the non-contact wireless charging apparatus using the magnetic-inductive method according to the preferred embodiment of the present invention, it is impossible to control the wireless charging apparatus and the portable terminal to a maximum matching position, thereby degrading the wireless power transmission efficiency.

### SUMMARY OF THE INVENTION

The present invention has been made in an effort to provide a wireless charging apparatus for a vehicle on a dashboard of the vehicle in a cavity form so as to perform stable and continuous wireless charging by preventing a portable terminal from being separated due to impact or shaking while a vehicle is traveling.

In addition, the present invention has been made in an effort to provide a wireless charging apparatus for a vehicle capable of automatically aligning a position of a primary side coil of the wireless charging apparatus for a vehicle to correspond to a position of a secondary side coil of the portable terminal according to the position of the secondary side coil of the portable terminal so as to implement maximum wireless power transmission.

According to a preferred embodiment of the present invention, there is provided a wireless charging apparatus for a vehicle, including: a cavity type charging receiving part formed on a dashboard of a vehicle to have an opening part thereon so as to charge a portable terminal; a pair of streamlined elastic fixing parts mounted in the cavity type charging receiving part, while being spaced apart from each other so as to correspond to each other, to press and fix the portable terminal; and a charging module mounted on a rear surface of the cavity type charging receiving part and mounted with a primary side coil transmitting a wireless power signal so as to automatically align and charge the primary side coil at a position of a secondary side coil of the portable terminal.

The bottom end of the opening part of the cavity type charging receiving part may serve as a separation prevention bump fixed so as to prevent the portable terminal from being separated.

Each streamlined elastic fixing part may include: a first distal end opened left and right to have elasticity so that the portable terminal is inserted and pressing and fixing the top end of the portable terminal; a second distal end fixed to the bottom end in the cavity type charging receiving part; and a plurality of bending portions formed between the first and second distal ends and so as to press and fix the side of the portable terminal.

Each streamlined elastic fixing part may be a wire type of elastic member or a plate type of elastic member.

The charging module may include: a coil position automatic aligning unit mounted with the primary side coil to automatically align the position of the primary side coil so as to correspond to the position of the secondary side coil of the portable terminal; and a charging circuit unit charging the portable terminal by generating the wireless power signal at the time of the maximum matching of the primary side coil and the secondary side coil by the coil position automatic aligning unit.

The coil position automatic aligning unit may include: a coil mounting part mounted on a rear surface of the cavity type charging receiving part to slidably mount the primary side coil in a vertical direction so as to correspond to the position of the secondary side coil of the portable terminal; and a coil transfer unit sliding the primary side coil mounted on the coil mounting part so as to be vertically transferred.

The coil mounting part may include: a base body having a first sliding unit provided on one surface thereof in a vertical direction and fixedly mounted on the rear surface of the cavity type charging receiving part; and a moving body mounted with the primary side coil and mounted with a second sliding unit corresponding to the first sliding unit of the base body to slide the primary side coil in a vertical direction.

The first sliding unit may be a guide protrusion formed on one surface of the base body and the second sliding unit may be a guide protrusion formed on one surface of the moving body to correspond to the guide protrusion.

The first sliding unit may be a guide groove formed on one surface of the base body and the second sliding unit may be a guide groove formed on one surface of the moving body to correspond to the guide groove.

The coil transfer unit may be a motor.

The charging circuit unit may include: an oscillation circuit generating the wireless power signal at the time of the maximum matching of the primary side coil and the secondary side coil; a power amplifier amplifying the generated wireless power signal; and a primary side coil transferred to the maximum matching position by the coil position automatic aligning unit to transmit the amplified wireless power signal to the portable terminal.

The charging circuit unit may further include a current/voltage sensor detecting a charging state of the portable terminal from the wireless power signal transferred through the primary side coil.

The wireless charging apparatus for a vehicle may further include a sensing sensor mounted between the pair of streamlined elastic fixing parts to detect whether the portable terminal is mounted.

The sensing sensor may be a mechanical sensing sensor or an electronic sensing sensor.

The mechanical sensing sensor may be a push switch.

The electronic sensing sensor may be an infrared sensor.

The wireless charging apparatus for a vehicle may further include a status display device formed on the front surface of the cavity type charging receiving part to display the charging state of the portable terminal for each step.

The status display device may be a light emitting diode (LED).

### BRIEF DESCRIPTION OF THE DRAWINGS

FIG. 1 is a block diagram of a wireless charging apparatus for a vehicle according to a preferred embodiment of the present invention;

FIG. 2 is a diagram showing a state in which a portable terminal is received in a cavity type charging receiving part shown in FIG. 1;

FIGS. 3A to 3C are diagrams showing that a portable terminal is pressed and fixed to a streamlined elastic fixing part shown in FIG. 1;

FIGS. 4A to 4C are diagrams showing an example of various positions of coils mounted in the portable terminal shown in FIG. 2;

FIG. 5 is a diagram schematically showing a charging module shown in FIG. 1; and

FIG. 6 is a detailed block diagram of the charging module shown in FIG. 1.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

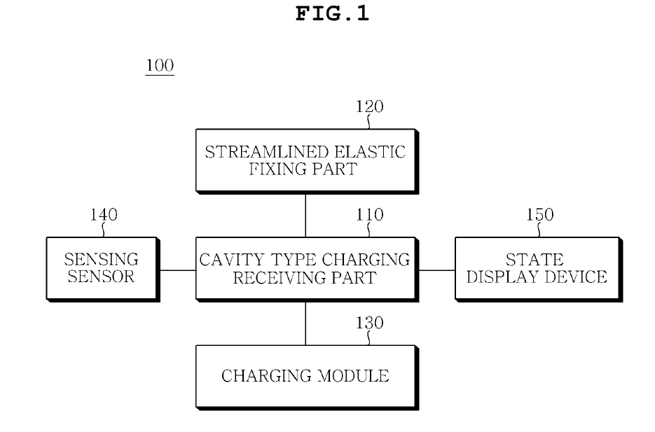

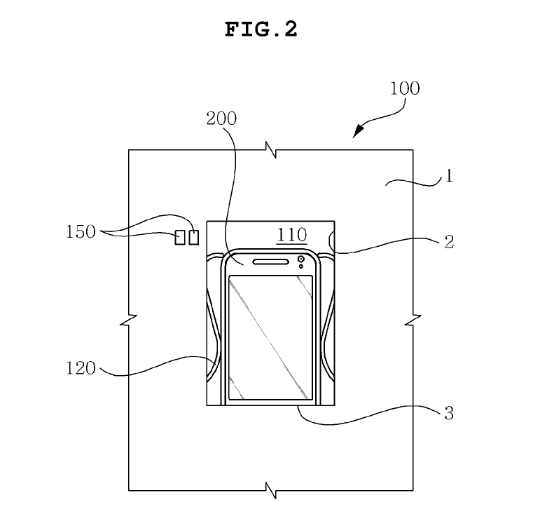

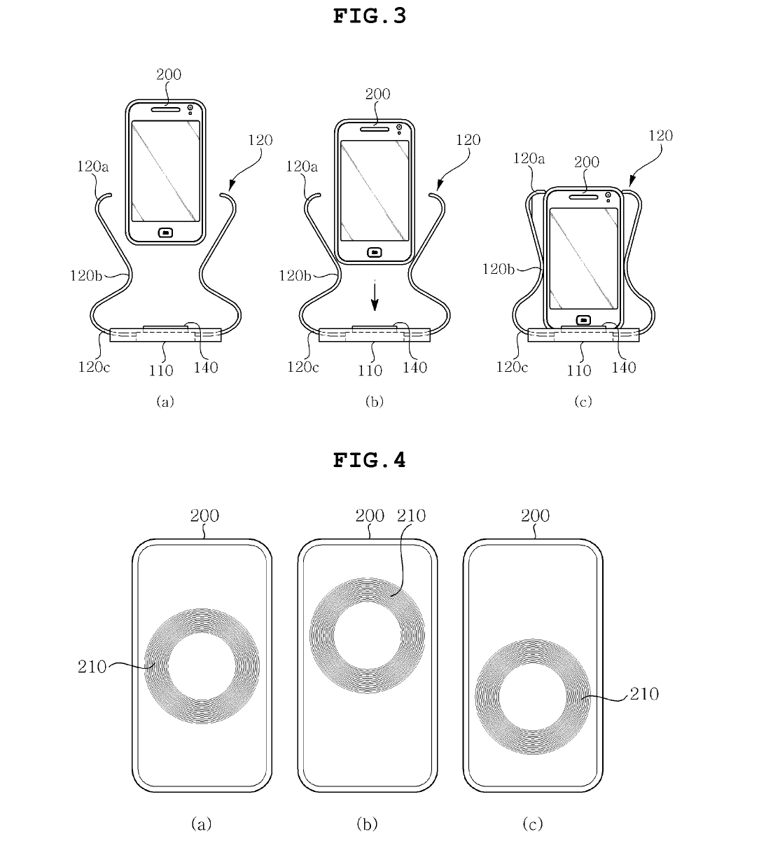

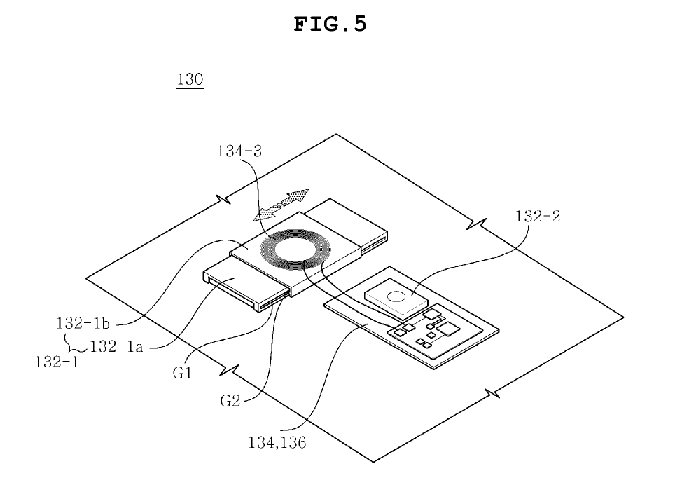

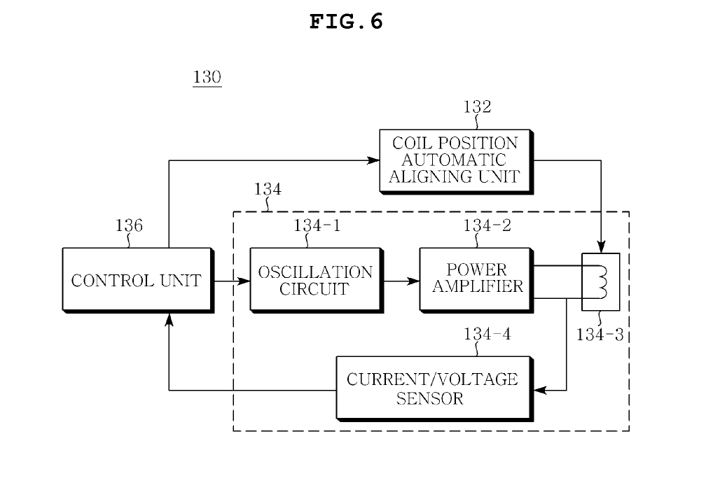

FIG. 1 is a block diagram of a wireless charging apparatus for a vehicle according to a preferred embodiment of the present invention, FIG. 2 is a diagram showing a state in which a portable terminal is received in a cavity type charging receiving part shown in FIG. 1, FIGS. 3A to 3C are diagrams showing that a portable terminal is pressed and fixed to a streamlined elastic fixing part shown in FIG. 1, FIGS. 4A to 4C are diagrams showing an example of various positions of coils mounted in the portable terminal shown in FIG. 2, FIG. 5 is a diagram schematically showing a charging module shown in FIG. 1, and FIG. 6 is a detailed block diagram of the charging module shown in FIG. 1.

Referring to FIG. 1, a wireless charging apparatus 100 for a vehicle according to a preferred embodiment of the present invention is configured to include a cavity type charging receiving part 110, a streamlined elastic fixing part 120, and a charging module 130.

The cavity type charging receiving part 110 is formed on a dashboard 1 of a vehicle having an opening part 2 thereon in a cavity type so as to charge a predetermined portable terminal 200.

The cavity type charging receiving part 110 may be mounted so as to receive the portable terminal 200 in the cavity type charging receiving part 110 through the opening part 2.

In this case, a bottom end 3 of the opening part of the cavity type charging receiving part 110 serves as a kind of separation prevention bump that fixes a bottom end of the portable terminal 200 and prevents separation due to impact or shaking while the vehicle is traveling.

The pair of streamlined elastic fixing parts 120 is mounted in the cavity type charging receiving part 110, while being spaced apart from each other so as to correspond to each other, to press and fix the portable terminal 200.

In detail, as shown in FIGS. 2 and 3A to 3C, each streamlined elastic fixing part 120 includes a first distal end 120a opened left and right to have elasticity so that the portable terminal 200 is inserted and pressing and fixing the top end of the portable terminal 200, a second distal end 120c fixed to the bottom end in the cavity type charging receiving part 110, and a plurality of bending portions 120b formed between the first and second distal ends 120a and 120c so as to press and fix the side of the portable terminal 200.

As the pair of streamlined elasticity fixing parts 120, for example, a wire type of elastic member or a plate type of elastic member may be used.

The charging module 130 is mounted on the rear surface of the cavity type charging receiving part 110 and is mounted with a primary side coil 134-3 transmitting a wireless power signal so as to automatically align and charge the primary side coil 134-3 at a position of a secondary side coil 210 of the portable terminal 200 fixed by the pair of streamlined elastic fixing parts 120.

As shown in FIGS. 4A to 4C, the secondary side coil 210 of the portable terminal 200 may be embedded at different positions according to the terminal.

The charging module 130 may transfer and align the primary side coil 134-3 so as to correspond to the position of the secondary side coil 210 according to the position of the secondary side coil 210 embedded at various positions.

As shown in FIGS. 5 and 6, the charging module 130 is configured to include a coil position automatic aligning unit 132, a charging circuit unit 134, and a control unit 136.

The coil position automatic aligning unit 132 is mounted with the primary side coil 134-3 to automatically align the position of the primary side coil 134-3 so as to correspond to the position of the secondary side coil 210 of the portable terminal 200 and the charging circuit unit 134 charges the portable terminal 200 by generating the wireless power signal at the time of the maximum matching of the primary side coil 134-3 and the secondary side coil 210 by the coil position automatic aligning unit 132.

In detail, the coil position automatic aligning unit 132 is configured to include a coil mounting part 132-1 and a coil transfer part 132-2 as shown in FIG. 5.

The coil mounting part 132-1 is mounted on the rear surface of the cavity type charging receiving part 110 to slidably mount the primary side coil 134-3 in a vertical direction so as to correspond to the position of the secondary side coil 210 of the portable terminal 200.

The coil mounting part 132-1 is configured to include the primary side coil 134-3 and a base body 132-1a having a first sliding unit provided on one surface thereof in a vertical direction and fixedly mounted on the rear surface of the cavity type charging receiving part 110 and a moving body 132-1b mounted with a second sliding unit corresponding to the first sliding unit of the base body 132-1a to slide the primary side coil 134-3 in a vertical direction.

For example, the first sliding unit may be a guide groove G1 formed on one surface of the base body 132-1a and the second sliding unit may be a guide protrusion G2 formed on one surface of the moving body 132-1b to correspond to the guide groove G1.

In addition, although not shown, the first and second sliding units may be formed reversely.

That is, the first sliding unit may be a guide protrusion (not shown) formed on one surface of the base body 132-1a and the second sliding unit may be a guide groove (not shown) formed on one surface of the moving body 132-1b to correspond to the guide protrusion.

The coil transfer unit 132-2 slides the primary side coil 134-3 mounted on the coil mounting part 132-1 so as to be vertically transferred. In detail, the coil transfer unit 132-2 vertically slides the moving body 132-1b of the coil mounting part 132-1 to transfer the primary side coil 134-3 mounted on the moving body 132-1b.

An example of the coil transfer unit 132-2 may include a motor.

The charging circuit unit 134 is configured to include an oscillation circuit 134-1, a power amplifier 134-2, and a primary side coil 134-3 as shown in FIG. 6.

The oscillation circuit 134-1 generates the wireless power signal to be transmitted to the portable terminal 200 at the time of the maximum matching of the primary side coil 134-3 and the secondary side coil 210 by the coil position automatic aligning unit 132.

The power amplifier 134-2 amplifies the generated wireless power signal and output the amplified wireless power signal to the primary side coil 134-3.

The primary side coil 134-3 is transferred to the maximum matching position by the coil position automatic aligning unit 132 to transfer the amplified wireless power signal to the portable terminal 200.

As a result, the portable terminal 200 receives and charges the transmitted wireless power signal.

In addition, the charging circuit unit 134 may further include a current/voltage sensor 134-4 that detects a charging state of the portable terminal 200 from the wireless power signal carried through the primary side coil 134-3.

Meanwhile, the wireless charging apparatus 100 for a vehicle according to the preferred embodiment of the present invention may further include a sensing sensor 140 sensing whether the portable terminal 200 is mounted and a status display device 150 displaying the charging state of the portable terminal 200, or the like, as shown in FIGS. 1 and 2A to 2C.

The sensing sensor 140 is mounted between the pair of streamlined elastic fixing parts 120 (in detail, second distal ends (120a)) to detect whether the portable terminal 200 is mounted.

As the sensing sensor 140, when the portable terminal 200 is mounted, for example, a mechanical sensing sensor sensing whether the portable terminal 200 is mounted by being operated like a push switch or an electronic sensing sensor sensing whether the portable terminal 200 is mounted by being operated like an infrared sensor may be used.

The status display device 150 is formed on the front surface of the cavity type charging receiving part 110 to display the charging state of the portable terminal 200 for each step.

For example, the status display device 150 may perform a display by different colors, such as a red color the case in which the mounted portable terminal 200 needs to be charged, a blue color the case in which the charging is completed, or the like, according to the signal input from the charging module 130 (in detail, the current/voltage sensor 134-4).

In addition, the colors of the status display device 150 divides the charging state of the portable terminal 200 for each step so as to be displayed by different colors for each step.

As the status display device 150, for example, a light emitting diode (LED) may be used.

As described above, the wireless charging apparatus 100 for a vehicle according to the exemplary embodiment of the present invention mounts the cavity type charging receiving part 110 having the opening part 2 for charging the portable terminal 200 on the dashboard 1 of the vehicle to fix the bottom end of the portable terminal 200 by the bottom end of the opening part 2 and fixes the side and top end of the portable terminal 200 by the pair of streamlined elastic fixing parts 120 mounted in the cavity type charging receiving part 110, thereby preventing the separation of the portable terminal 200 due to the impact or the shaking while the vehicle is traveling.

In addition, the wireless charging apparatus 100 for a vehicle according to the preferred embodiments of the present invention can automatically align the position of the primary side coil 134-3 of the wireless charging apparatus 100 for a vehicle to correspond to the position of the secondary side coil 210 according to the position of the secondary side coil 210 of the portable terminal 200 so as to implement the maximum power transmission, thereby improving the wireless power transmission efficiency.

As set forth above, the preferred embodiments of the present invention can mount the cavity type charging receiving part having the opening part for charging the portable terminal on the dashboard of the vehicle to fix the bottom end of the portable terminal by the bottom end of the opening part and fix the side and top end of the portable terminal by the pair of streamlined elastic fixing parts mounted in the cavity type charging receiving part, thereby preventing the separation of the portable terminal due to the impact or the shaking while the vehicle is traveling.

In addition, the preferred embodiments of the present invention can automatically align the position of the primary side coil of the wireless charging apparatus for a vehicle to correspond to the position of the secondary side coil according to the position of the secondary side coil of the portable terminal so as to implement the maximum power transmission, thereby improving the wireless power transmission efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A wireless charging apparatus for a vehicle, comprising:
a cavity type charging receiving part formed on a dashboard of a vehicle to have an opening part thereon so as to charge a portable terminal;
a pair of streamlined elastic fixing parts mounted in the cavity type charging receiving part, while being spaced apart from each other so as to correspond to each other, to press and fix the portable terminal; and
a charging module mounted on a rear surface of the cavity type charging receiving part and mounted with a primary side coil transmitting a wireless power signal so as to automatically align and charge the primary side coil at a position of a secondary side coil of the portable terminal.

2. The wireless charging apparatus for a vehicle as set forth in claim 1, wherein the bottom end of the opening part of the cavity type charging receiving part serves as a separation prevention bump fixed so as to prevent the portable terminal from being separated.

3. The wireless charging apparatus for a vehicle as set forth in claim 1, wherein each streamlined elastic fixing part includes:
a first distal end opened left and right to have elasticity so that the portable terminal is inserted and pressing and fixing the top end of the portable terminal;
a second distal end fixed to the bottom end in the cavity type charging receiving part; and
a plurality of bending portions formed between the first and second distal ends and so as to press and fix the side of the portable terminal.

4. The wireless charging apparatus for a vehicle as set forth in claim 1, wherein each streamlined elastic fixing part is a wire type of elastic member or a plate type of elastic member.

5. The wireless charging apparatus for a vehicle as set forth in claim 1, wherein the charging module includes:
a coil position automatic aligning unit mounted with the primary side coil to automatically align the position of the primary side coil so as to correspond to the position of the secondary side coil of the portable terminal; and
a charging circuit unit charging the portable terminal by generating the wireless power signal at the time of the maximum matching of the primary side coil and the secondary side coil by the coil position automatic aligning unit.

6. The wireless charging apparatus for a vehicle as set forth in claim 5, wherein the coil position automatic aligning unit includes:
a coil mounting part mounted on a rear surface of the cavity type charging receiving part to slidably mount the primary side coil in a vertical direction so as to correspond to the position of the secondary side coil of the portable terminal; and
a coil transfer unit sliding the primary side coil mounted on the coil mounting part so as to be vertically transferred.

7. The wireless charging apparatus for a vehicle as set forth in claim 6, wherein the coil mounting part includes:
a base body having a first sliding unit provided on one surface thereof in a vertical direction and fixedly mounted on the rear surface of the cavity type charging receiving part; and
a moving body mounted with the primary side coil and mounted with a second sliding unit corresponding to the first sliding unit of the base body to slide the primary side coil in a vertical direction.

8. The wireless charging apparatus for a vehicle as set forth in claim 7, wherein the first sliding unit is a guide groove formed on one surface of the base body and the second sliding unit is a guide protrusion formed on one surface of the moving body to correspond to the guide groove.

9. The wireless charging apparatus for a vehicle as set forth in claim 7, wherein the first sliding unit is a guide protrusion formed on one surface of the base body and the second sliding unit is a guide groove formed on one surface of the moving body to correspond to the guide protrusion.

10. The wireless charging apparatus for a vehicle as set forth in claim 6, wherein the coil transfer unit is a motor.

11. The wireless charging apparatus for a vehicle as set forth in claim 5, wherein the charging circuit unit includes:
an oscillation circuit generating the wireless power signal at the time of the maximum matching of the primary side coil and the secondary side coil;
a power amplifier amplifying the generated wireless power signal; and
a primary side coil transferred to the maximum matching position by the coil position automatic aligning unit to transmit the amplified wireless power signal to the portable terminal.

12. The wireless charging apparatus for a vehicle as set forth in claim 11, wherein the charging circuit unit further includes a current/voltage sensor detecting a charging state of the portable terminal from the wireless power signal transferred through the primary side coil.

13. The wireless charging apparatus for a vehicle as set forth in claim 1, further comprising a sensing sensor mounted between the pair of streamlined elastic fixing parts to detect whether the portable terminal is mounted.

14. The wireless charging apparatus for a vehicle as set forth in claim 13, wherein the sensing sensor is a mechanical sensing sensor or an electronic sensing sensor.

15. The wireless charging apparatus for a vehicle as set forth in claim 14, wherein the mechanical sensing sensor is a push switch.

16. The wireless charging apparatus for a vehicle as set forth in claim 14, wherein the electronic sensing sensor is an infrared sensor.

17. The wireless charging apparatus for a vehicle as set forth in claim 1, further comprising a status display device formed on the front surface of the cavity type charging receiving part to display the charging state of the portable terminal for each step.

18. The wireless charging apparatus for a vehicle as set forth in claim 17, wherein the status display device is a light emitting diode (LED).
